(19) United States
(12) Patent Application Publication
(10) Pub. No.: US 2007/0266526 A1
(43) Pub. Date: Nov. 22, 2007

(54) Handle device

(76) Inventor: Simon John Buckingham, Portsmouth (GB)

Correspondence Address: MANELLI DENISON & SELTER PLLC, 7t Floor, 2000 M Street, N.W., Washington, DC, 20036-3307, US

(21) Appl. No.: 11/436,859

(22) Filed: May 19, 2006

(51) Int. Cl. A47J 45/07

(52) U.S. Cl. 16/425

(57) ABSTRACT

The invention relates to a handle device 1 for carrying an object with an extending lip such as a plate. The handle device 1 comprises a handle body 2 for placement in the hand of a user.

A first pair of spaced apart fingers 5, 6 extend a first length from one end of the handle body 2, and a second finger 7 extends a second length from one end of the handle body and in a plane spaced from the pair of fingers. In use the lip of an object being insertable in between the first pair of fingers and the second finger with first pair of fingers and second finger forming a cantilever to support the object when carried by the handle body.

### BACKGROUND

The present invention relates to a handle device, for example of the type for carrying objects, in which the handle has an extended lip. The objects that the handle device carries are more particularly plates and cooking containers, especially when such objects are hot.

Many elderly or infirm people find it difficult to carry hot plates or cooking containers, as they risk burning themselves. Also elderly or infirm people with arthritic hands or deformed hands find it difficult to carry plates or cooking containers.

### PRIOR ART

An example of a handle device is described in UK Patent 680932 (Hawley) in which there is shown a device for gripping a portion of a mat, the device having three or more prongs for engagement with an edge of the mat. The prongs are finned and typically curved so as to be able to be resiliently deformed in order to grip an edge portion of a mat. Prongs are shaped so as to define between adjacent prongs a space for gripping an edge of the mat.

U.S. Pat. No. 6,393,973 (Veloet al) discloses a cooking utensil having a removable handle grip. The utensil comprises a bowl on which a portion of its periphery has an outward lip or rim. Disposed on the lip or rim is a small orifice for receiving a handle. The handle comprises an upper part limited by a stop and a bottom portion which extends in a plane, which intersects the top of the handle behind an abutment. In use the handle portion is gripped by a user, in such a manner that engagement of an upper portion of the handle ensures that the bowl or cooking utensil is held between an engagement means and the bottom portion of a handle. The handle is specifically designed so as to engage only the bowl in order to lift or carry it.

UK Patent 1 138 497 (Hafele) describes a carrying device for carrying rigid or semi-rigid sheets of material such as slabs or plates. The device is a grip comprising three prongs linked together by an angled cross member. The device is capable of abutting against a longitudinal edge of a panel and providing a grip for a carrier. In use, two or more devices are used in order to carry a large panel or sheet.

UK Patent Application GB-A-2 412 082 (Read) describes a dishware carrier for carrying hot plates or bowls. The carrier comprises an upper member and a lower member secured to a handle. The members are typically elongate in nature and are defined by prongs or sections of bent tubular material.

UK Patent Application GB-A-2 356 595 (Smith) describes a device for gripping plates or dishes. The device is hand held and comprises opposing upper and lower claw configurations. In an alternative embodiment a central claw is bent into an arcuate form for engaging with a lip or periphery of a plate.

Although the above mentioned devices were to a large degree effective, a number of them suffered from certain disadvantages. Firstly there was a risk that a plate or bowl could slip from the gripping device with the risk that it was dropped or food was spilt. Secondly, there was the disadvantage that because some devices were specifically designed for only one specific type of bowl or plate, for example due to a particular engagement mechanism, the carrying device could only be used to lift or carry that specific plate or bowl. A third disadvantage was the risk of damage to plate or bowl posed by some types of existing carriers. This arose as a result of the distance between an engagement point and a pivot point defined by and disposed on the handle or gripper. In practice, where the gripper acted on fulcrum points, and where fulcrum points were widely spaced from one another or offset from one another in a radial direction, there was a risk, when engaging with a plate, that the plate could be damaged. This arose from the fact that a relatively high bending moment was established between contact points that were widely spaced, with the result that, where bending moments were high, for example where a plate was heavily loaded with food on an opposite edge from that where the gripper engaged, there was a risk that a plate might crack or fracture due to the amount of stress which was caused when the plate was lifted. Such stresses arose as a result of tension, in an upper surface of the plate due to the bending forces and from any jolts or shocks, for example arising from the person carrying the plate, being directly transmitted to the plate at the fulcrum points.

Finally, once engaged by a carrier, there was a slight risk of a plate becoming dislodged as a result of lateral movement, for example inadvertent jerking, shaking or accidental knocking. Such inadvertent motions are not uncommon where some users suffer from muscular shaking or diseases such as Parkinson's disease.

The present invention therefore arose in order to address specifically the above points and to provide an improved plate gripper capable of releasably attaching to the rim of a plate and supporting the plate in such a manner that it was capable of being safely carried, minor lateral movement did not dislodge the plate from the handle or gripper and that the plate was not exposed to the risk of fracture.

The invention seeks to provide a handle device to solve this problem.

### SUMMARY OF THE INVENTION

According to the present invention there is provided a handle device for carrying an object with an extending lip comprising:
a) a handle body for placement in the hand of a user, and
b) a first pair of spaced apart fingers extending a first length from one end of the handle body, and a second finger extending a second length from one end of the handle body and in a plane spaced from the pair of fingers, in use the lip of an object being insertable in between the first pair of fingers and the second finger with first pair of fingers and second finger forming a cantilever to support the object when carried by the handle body, characterised in that a resiliently deformable means is supported by the fingers, whereby in use the resiliently deformable means is arranged to contact upper and lower surfaces of a plate.

Preferably the resiliently deformable means is formed from a synthetic plastics material. An advantage of this is that the material is able to “give” when a handle is inserted onto a lip of a plate, thereby acting as a detent mechanism. The detent mechanism acts in a way to grab or lock an edge or rim of a plate so that, in use, a degree of tipping or tilting can be tolerated without the plate falling from the handle.

An advantage of the present invention is that it emulates a natural pincer type grip of a users hand, where the thumb and forefinger are employed to grasp or lift a plate, particularly when accessing a cupboard or microwave oven to lift the plate.

In Prior Art devices a plate or bowl had to be carried in a level plane in order for reaction forces to keep it held firmly in the handle. However, in the present invention, due to the locking or detent mechanism, provided by the resiliently deformable members acting as gripping portions, the plate does not fall from the handle despite a minor degree of tilting. Similarly when first engaging a plate in order to lift it, the handle is presented with its axis at an angle to the plane of the plate. This is hereinafter referred to as the “angle of attack” and is typically between 20° and 60°. Thus locking is not achievable when presenting the handle with its axis parallel to the plane of the plate. There is likewise a need to lift the handle when detaching the handle from the plate. The unique arrangement of the resiliently deformable means arranged to contact upper and lower surfaces of a plate grippers helps achieve this locking of the handle to the plate.

Preferably the resiliently deformable means are dome shaped and are dimensioned and arranged so that, in use, convex portions are in contact with upper and lower surfaces of a plate. An advantage of this is that the resiliently deformable means act as a gripping portions or grippers as they firstly deform in order to present a surface that is in intimate contact with the plate being held and secondly offer a friction providing surface.

Advantageously the domed grippers or gripper portions are located on first and second support members or fingers in a position which ensures that two of the three grippers are located on a lower surface of a plate and the third is on an upper surface, at a point interposed between the other two. This spacing of the grippers ensures that load is shared over a relatively larger surface area, when compared with existing devices, thereby lowering the potential stresses applied to a plate.

The grippers are so located, dimensioned and arranged as to allow an insertion angle of a plate, into the handle device at an angle typically between 5° and 75°.

Advantageously the gripper portions are placed forward of an end stop. The location of the end stop may be defined by fingers which support the two lower or underside grippers. An advantage of this is that the lower grippers are placed in a position well forward of the upper gripper and well within an envelope defined by the plate being lifted. However, the distance between the end stop and the lower fingers is sufficiently long so as to fit plates. However, the distance between the end stop and the upper finger must not be too long otherwise there is a risk that the upper finger or dome contacts the eating surface of the plate or the food on it.

Ideally the distance between the lower grippers is less than 15 cm and greater than around 2-3 cm. Advantageously the distance is between 5 cm and 12 cm and most preferably the distance between lower grippers is around 6-10 cm. The third or upper gripper ideally is positioned on a line that bisects the lower grippers and is preferably between 1 cm and 4 cm closer to the end stop than a line define between the two lower grippers. The advantage of this arrangement is to ensure that the handle is capable of receiving plates of various sizes and differing radii of curvature.

The normal distance between an orthogonal line, passing through the centre of the first gripper and a plane defined by the second and third grippers, is typically less then 5 mm and advantageously between 2 mm and 4 mm.

Preferably a lip contact point is provided on each of the first pair of fingers extending towards the second finger, and a lip contact point is provided on the second finger extending towards the first pair of fingers.

Preferably the handle device is made as a unitary product. The handle device may be moulded as a unitary moulding.

Ideally the handle is longer than a users hand, and typically longer than 10 cm, so as a user can locate the handle of the gripper in the hand in such a way that the weight of the plate is transferred beyond the wrist as a result of the length of the handle. The result is a user does not have to support any significant weight at the wrist (which may be weak) thus avoiding excessive muscular and joint strain, because the handle extends beyond the wrist joint and past the muscles (thenar eminence) in the hand.

Embodiments of the invention will now be described, by way of examples only, and with reference to the accompanying drawings in which:

### BRIEF DESCRIPTION OF THE FIGURES

FIG. 1 shows a perspective view of a preferred embodiment of a handle;

FIG. 2 shows a perspective view of the handle of FIG. 1, in use, carrying a plate;

FIGS. 3 and 4 show side views of alternative embodiments of a handle;

FIGS. 5 and 6 show plan and side views of another alternative embodiment of a handle;

FIGS. 7 and 8 show plan and side views of a further embodiment of a handle;

FIG. 9 shows an end elevation view of the embodiment in FIGS. 7 and 8;

FIGS. 10 and 11 show plan and side views of a further embodiment of a handle;

FIG. 12 shows an end elevation view of the embodiment in FIGS. 10 and 11; and

FIGS. 13 and 14 show plan and side views of a further embodiment of the handle.

### DETAILED DESCRIPTION OF PREFERRED EMBODIMENTS OF THE INVENTION

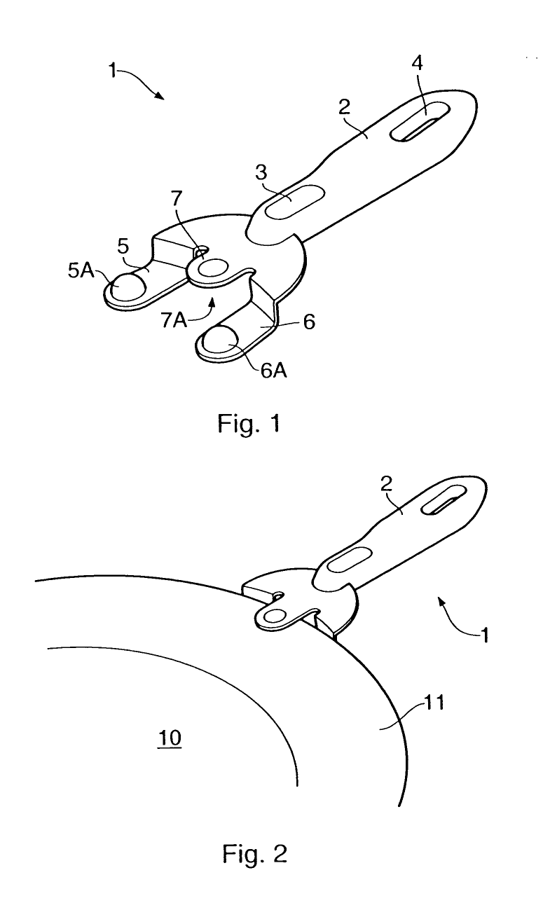

Referring to FIGS. 1 and 2 there is shown a handle device 1 for carrying an object such as plate 10 with an extending peripheral lip 11.

Device 1 has a handle body 2 for placement in the hand of a user. Body 2 has a thumb recess 3 at one first end and a slot 4 to hang the body 2 on a hook or the like. Body 2 may be over-moulded with a rubber-like material to make it more comfortable to hold in the hand.

A first pair of spaced apart fingers 5, 6 extend a first length from the first end of the handle body 2, and a second finger 7 extends a second length (shorter than the first length) from the first end of the handle body and in a plane spaced from the pair of fingers 5, 6.

Object lip contact points in the form of domes 5A, 6A are provided respectively on the first pair of fingers 5, 6 extending towards the second finger, and an object lip contact point in the form of dome 7A is provided on the second finger extending towards the first pair of fingers. The contact points in the form of domes 5A, 6A and 7A include a rubberized surface to provide a better grip on the lip of the object. An arcuate rim 30 acts as an end stop

The first pair of fingers and second finger are spaced apart a distance such that the tips of the domes 5A, 6A are spaced apart from the tip of dome 7A by an amount that is sufficient to receive a lip of a plate. This enables a plates of varying thickness and size to be inserted and the handle and once instead and received by the handle to lie flat by way of the domes grippers, effectively “reaching their own level”.

Handle 1 may be moulded as a unitary moulding of plastics or may be formed from other material or combinations or material.

In use the lip 11 of an object such as plate 10 is insertable in between the first pair of fingers and the second finger with first pair of fingers and second finger forming a cantilever to support the object when carried by the handle body 2. The three domes 5A, 6A, 7A provide three contact points with the plate lip.

The invention may take a form different to that specifically described above. For example the device could be designed so that the first pair of fingers could be on top of the lip and the second finger on the bottom of the lip (in which case the second length may be longer than the first length).

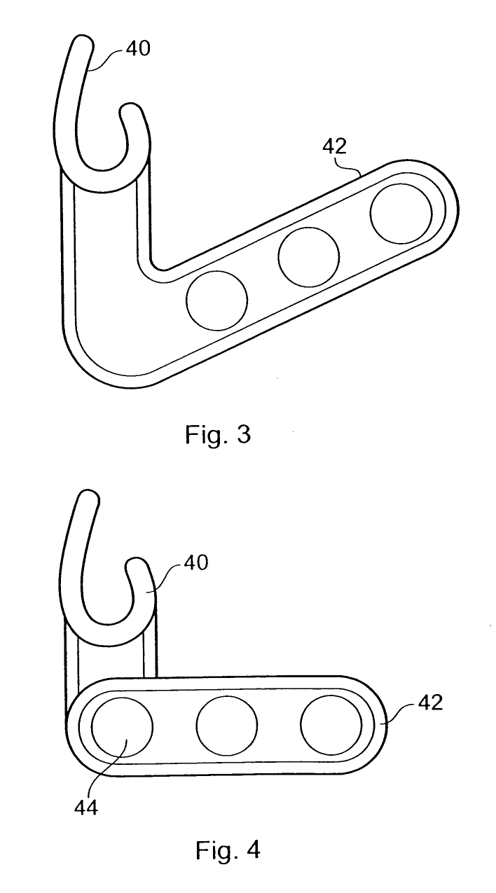

FIGS. 3 to 14 show various views of alternative embodiments of a handle in which like parts bear the same reference numerals as FIGS. 1 and 2.

Referring to FIGS. 3 to 15 there are shown alternative embodiments of a handle, FIG. 3 shows a handle with an angled jaw 40 and an integral handle 42. In FIG. 4 the handle is mounted on the gripper by way of a hinge 44 to enable it to be rotated with respect thereto.

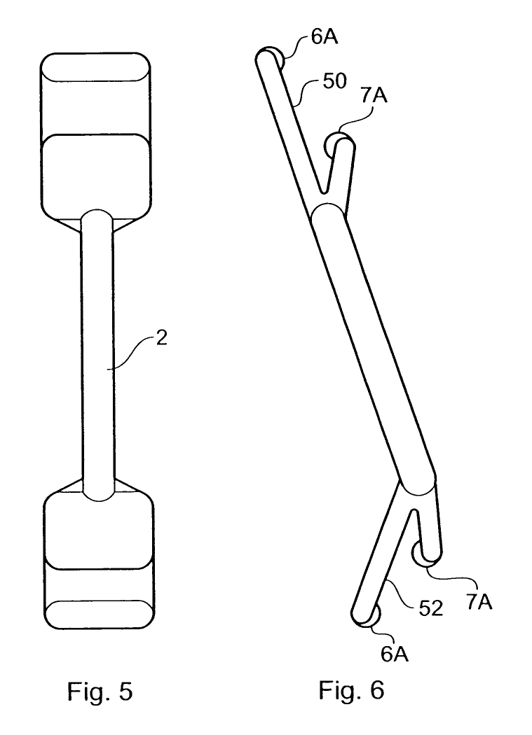

FIGS. 5 and 6 show side and plan views of an alternative embodiment, having an engagement mechanism 50 and 52 at either end of handle 2.

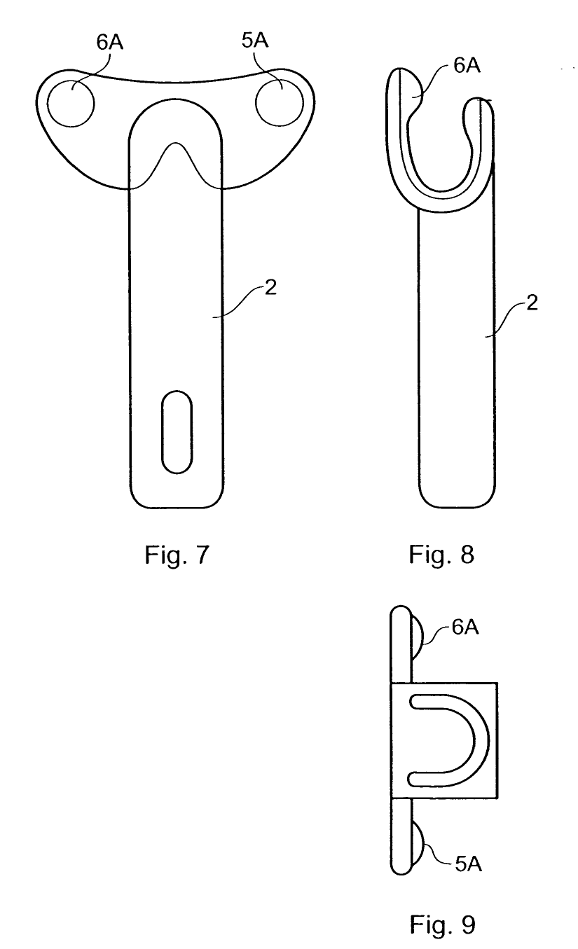

FIGS. 7 and 8 show side and plan views and FIG. 9 shows an end elevation view of a further embodiment.

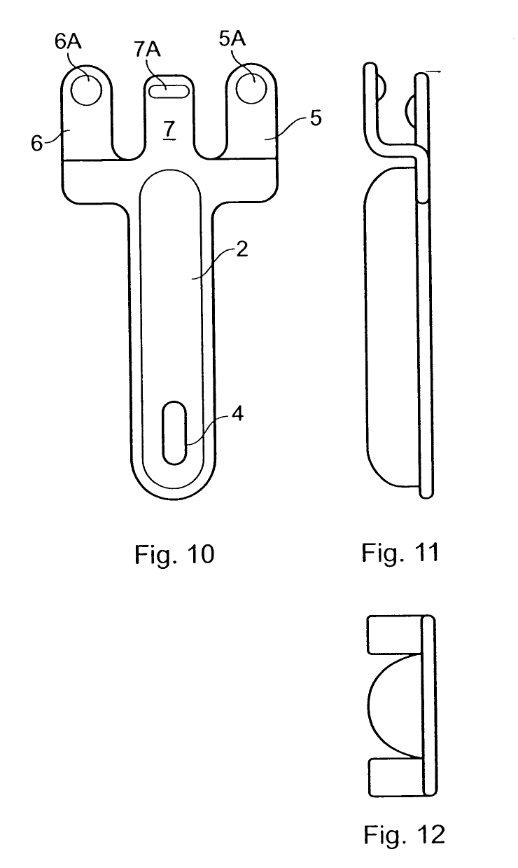

FIGS. 10 and 11 show plan and side views and FIG. 12 an end elevation view of another embodiment.

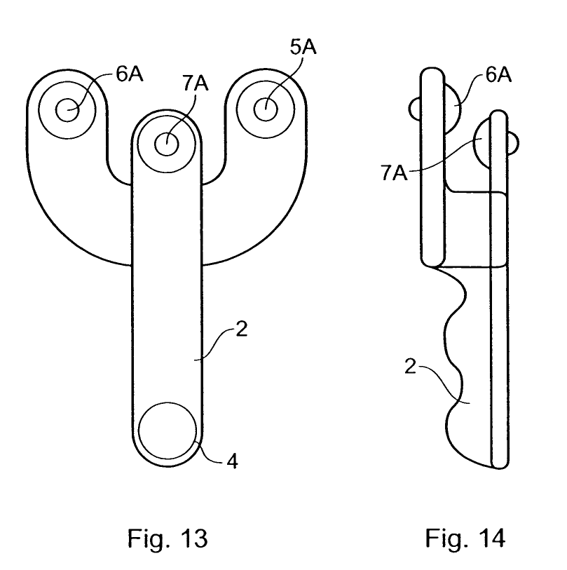

FIGS. 13 and 14 show plan and side views of a further embodiment.

The handle device of the invention may be used to carry objects other than plates, e.g. cooking containers. Also it will be appreciated that the handle can be formed from a single moulding. Ideally as the handle is smooth it is readily washed and sterilised.

Further modifications will be apparent to those skilled in the art without departing from the scope of the present invention. For example the handle may be textured to improve grip and all external surfaces shaped and contoured to remove any ‘dirt traps’, thereby facilitating sterilisation of the handle.

1. A handle device for carrying an object with an extending lip comprising:
a) a handle body for placement in the hand of a user, and
b) a first pair of spaced apart fingers extending a first length from one end of the handle body, and a second finger extending a second length from one end of the handle body and in a plane spaced from the pair of fingers, in use the lip of an object being insertable in between the first pair of fingers and the second finger with first pair of fingers and second finger forming a cantilever to support the object when carried by the handle body, characterised in that a resiliently deformable means is supported by the fingers, whereby in use the resiliently deformable means is arranged to contact upper and lower surfaces of a plate.

2. A handle device according to claim 1 wherein the resiliently deformable means are formed from a synthetic plastics material.

3. A. handle device according to claim 1 wherein the first pair of fingers is longer than the second finger.

4. A handle device according to claim 1, wherein the resiliently deformable means is in the form of a dome and are dimensioned and arranged so that, in use, convex portions are in contact with upper and lower surfaces of a plate.

5. A handle device according to claim 1 wherein the resiliently deformable means are located on first and second support members or fingers in a position which ensures that, in use, two of the three domes are located on a lower surface of a plate and the third is on an upper surface, at a point interposed between the other two.

6. A handle device according to claim 5 wherein the resiliently deformable means are so located, dimensioned and arranged as to allow a plate to be inserted at an angle typically between 5° and 75°.

7. A handle device according to claim 1 wherein the resiliently deformable means are placed forward of an end stop.

8. A handle device according to claim 1 wherein the distance between the resiliently deformable means on the first finger is less than 15 cm.

9. A handle device according to claim 8 wherein the distance is between the resiliently deformable means is greater than 5 cm and less than 12 cm.

10. A handle device according to claim 9 wherein the distance between the resiliently deformable means is between 8 and 10 cm.

11. A handle device according to claim 1 wherein the resiliently deformable means are positioned to ensure that the handle is capable of receiving plates of various sizes and differing radii of curvature.

12. A handle device according to claim 1, wherein the handle device is moulded as a unitary moulding.
